(19) United States
(12) Patent Application Publication
(10) Pub. No.: US 2010/0044303 A1
(43) Pub. Date: Feb. 25, 2010

(54) FILTRATION CARTRIDGE CO-OPERATING WITH A CENTRAL TUBE AND COMPRISING A RADIALLY-RETAINED SEAL MOUNTED IN A CAVITY FOR CO-OPERATING WITH SAID TUBE

(75) Inventors: Pascal Perrault, Gouesnach (FR); Emmanuel Page, Combrit (FR); Gildas Le Men, Guengat (FR); Jean-Luc Guichaoua, Combrit (FR); Arnaud Le Ven, Ergue Gaberic (FR); Loïck Menez, Fouesnant (FR)

Correspondence Address: HAMRE, SCHUMANN, MUELLER & LARSON, P.C., P.O. BOX 2902, MINNEAPOLIS, MN, 55402-0902, US

(73) Assignee: Cummins Filtration IP Inc., Minneapolis, MN (US)

(21) Appl. No.: 12/516,031

(22) PCT Filed: Nov. 15, 2007
(86) PCT No.: PCT/EP07/62369

§ 371 Date: Jun. 2, 2009

(30) Foreign Application Priority Data
Nov. 24, 2006 (FR) 06/10289

(51) Int. Cl. B01D 27/04; B01D 29/15

(52) U.S. Cl. 210/497.01

(57) ABSTRACT

The object of the invention is a filter cartridge of a filter assembly for fluid circulating in an engine or a hydraulic machine, designed to cooperate with a central tube, said cartridge comprising a filtration medium and at least one end flange integrated with said medium, said flange projecting to form a cavity for a gasket, characterized in that said cavity incorporates radial retention means for said gasket.

The invention pertains to the field of designing and constructing filter assemblies for filtering circulating fluids in engines or hydraulic machines.

Such filter assemblies consist of a filter element inside of which is disposed a filter cartridge, as a general rule cylindrical in shape and comprising a filtration medium, which can be made, for example, of paper, cardboard or felt. This filtration medium is typically bound by two end flanges.

There are two possible scenarios.

The filter cartridges either cooperate with a central tube, integrated or not with the flanges (the case wherein the cartridge is integrated with a tube designed to cooperate with another tube fix-mounted in the filter assembly is also conceivable), whose outer diameter is in the proximity of the inner diameter of the filtration medium, thus preventing deformations of the medium caused by the pressure acting inside the filter assembly.

Or the cartridges are inserted in a tube whose inner diameter is in the proximity of the outer diameter of the filtration medium, in order to prevent deformations of the medium caused by passage of the fluid from the central space of the medium to the outside of the medium.

According to a standard technique, the filter assemblies employ a support tube on which the filter cartridge is directly mounted, the tube being fix-mounted in the filter assembly.

According to still another technique, the bottom flanges of the cartridges project outwards so as to provide a means of positioning and securing the cartridge in place in the filter assembly, wherein in this case the central tube is integrally mounted and dismantled with the cartridge.

The invention relates to filter assemblies in which the tubes are permanently mounted.

Typically, there are several factors to be considered when designing a support tube:
the supporting of the filtration medium, of which optimum assurance is required (as a general rule, the tube must be as close as possible to the medium);
a minor “pressure loss” or drop in pressure of the fluid as it flows into the tube and through the medium;
minimum rubbing and/or interference with the filter cartridge gasket(s) during mounting or replacement of the filter cartridge on the tube.

According to a standard technique, the gaskets designed for cooperation with the support tubes are mounted in cavities arranged in the projection of one of the cartridge flanges.

These gaskets can be ring-shaped or according to a more recent technique, they can comprise a plurality of lobes giving the gasket an “h”, “l”, or “X”-shaped cross-section.

The multi-lobed gaskets are in practice very stiff and offer little latitude for displacement.

For certain cartridge applications, preference is therefore given to the use of ring gaskets, as the latter are relatively flexible.

In spite of the care taken in designing support tubes so as to prevent rubbing with the gaskets, such rubbing still occurs.

As the cartridge is being positioned on the support tube, such rubbing may be sufficient to dislodge the gasket, at least partially, from the cavity in which it resides. Obviously in this case the gasket will not be correctly positioned and a satisfactory seal is no longer assured, or lacking altogether.

During replacement of the cartridge, and more precisely during removal of the latter from the cistern, it has been observed in practice that the rubbing of the gasket on the tube can also cause the latter to dislodge. There is thus the risk of causing the gasket to detach completely from the cavity and fall into the cistern.

If the user notices this phenomenon, it is very difficult for him to retrieve the gasket and in any event, retrieving the gasket may result in a relatively significant loss of time.

On the other hand, should the user fail to notice that the gasket dropped into the cistern, he may still succeed in installing a new cartridge. Obviously in this case the presence of the “loose” gasket in the cistern can lead to malfunctioning of the filter assembly.

The objective of the invention is notably to mitigate the disadvantages of the prior art.

More precisely, the objective of the invention is to propose a filter cartridge that prevents, or at least considerably reduces, the effects of the rubbing of the tube on the positioning of the gasket.

The objective of the invention is likewise to provide a filter cartridge that can be assembled easily and quickly.

The objective of the invention is also to provide a filter cartridge that provides a good seal between itself and the tube supporting it.

Another objective of the invention is to provide a filter cartridge with a simple design that is easy to use and cheap to produce.

These objectives, as well as others that will be disclosed later on, are achieved with the invention, the object of which is a filter cartridge of a filter assembly for fluid circulating in an engine or a hydraulic machine, designed to cooperate with a central tube, said cartridge comprising a filtration medium and at least one end flange integrated with said medium, said flange projecting to form a cavity for a gasket, characterized in that said cavity incorporates radial retention means for said gasket.

Thanks to the invention, it is assured that the gasket remains seated in the cavity regardless of the rubbing of the gasket against the support tube as the cartridge is installed or removed.

The gaskets, including more flexible ones such as ring gaskets, are thus radially constrained to assume the shape of the cavity without being able to become detached there from.

Indeed, the gasket can only be removed from the cavity by subjecting it to relatively significant radial deformation, which is no longer possible with the retention means of the invention.

According to a preferred solution, said retention means comprise at least one element projecting inside said cavity and penetrating at least one recess of said gasket.

An especially simple and effective means of radially retaining the gasket in the cavity is thus obtained without compromising the seal between the cartridge and the support tube and without causing interference with the support tube while installing or replacing the cartridge.

According to a first embodiment, said projecting element and said recess extend 360°.

According to a preferred embodiment, said retention means comprise a plurality of elements projecting inside said cavity and in each case extending in an arc.

A number of three projecting elements regularly spaced inside the cavity, for example, can in fact suffice for effective retention of the gasket.

In this case, said gasket advantageously has recesses corresponding in number and shape to those of said projecting elements.

The gasket is thus not only retained radially but also against rotation around its center axis. In effect, the projecting elements form stops for the correspondingly shaped recesses.

Preference is given to said gasket having on each of its surfaces at least one recess corresponding to said projecting elements.

The gasket can thus be inserted in the cartridge with either surface facing either way, thus preventing risks of human error during installation.

In this case said recesses of one of the surfaces are advantageously alternated with respect to the recesses of the other surface of said gasket.

According to an advantageous characteristic, said cavity is bound by a part of said flange, by a crown integrated with said flange and extending there from, and by a cover directly mounted and fixed on said crown.

The operation of installing a gasket in a cartridge of the invention is thus greatly facilitated.

Indeed, in the absence of the cover, the access is free for installation of the gasket in the crown along the longitudinal direction of the filter, while taking care to align the projecting element(s) correctly with the retention means. Once the gasket is correctly positioned in the crown, the cover is then positioned and fixed.

In this case preference is given to said cover having, on the cavity side, at least one boss penetrating said recess(es).

An ideal retention of the gasket in the cavity can thus be achieved, the radial retention means acting on each of the surfaces of the gasket.

It is therefore understood that retention means can be provided on both the cover and on a part of the flange. However, provision of retention means on only one of these two elements is also conceivable.

Said cover advantageously has a shoulder resting on said crown.

Such a characteristic contributes to correct positioning and achievement of an effective fixation of the cover on the crown.

According to another advantageous characteristic, said gasket has two bosses designed to come into contact with said center tube.

A perfect seal with the support tube is thus achieved by creating a double support of the gasket against the tube.

According to still another advantageous characteristic, said gasket has two lobes extending in a divergent manner with respect to each other, each of said lobes fitting into a corner of said cavity.

The gasket thus consists of a deformable part capable of being compressed towards the bottom of the cavity (formed by the crown), thus improving the seal.

According to an advantageous solution, said retaining means with said recess(es) provide a clearance allowing a radial displacement of said gasket.

A slight radial mobility of the gasket within the cavity is thus allowed, thus enhancing its capacity to form a seal, particularly in the aforementioned case where the gasket has two divergent lobes. In effect, the pressure acting on the boss side imposes radial constraints, which tend to displace the gasket radially and centrifugally, the lobes then tending to flatten themselves against the bottom of the cavity.

Other characteristics and advantages of the invention will be disclosed more clearly on reading the following description of a preferred embodiment of the invention, given as a non-limiting, illustrative example, with the appended drawings wherein:

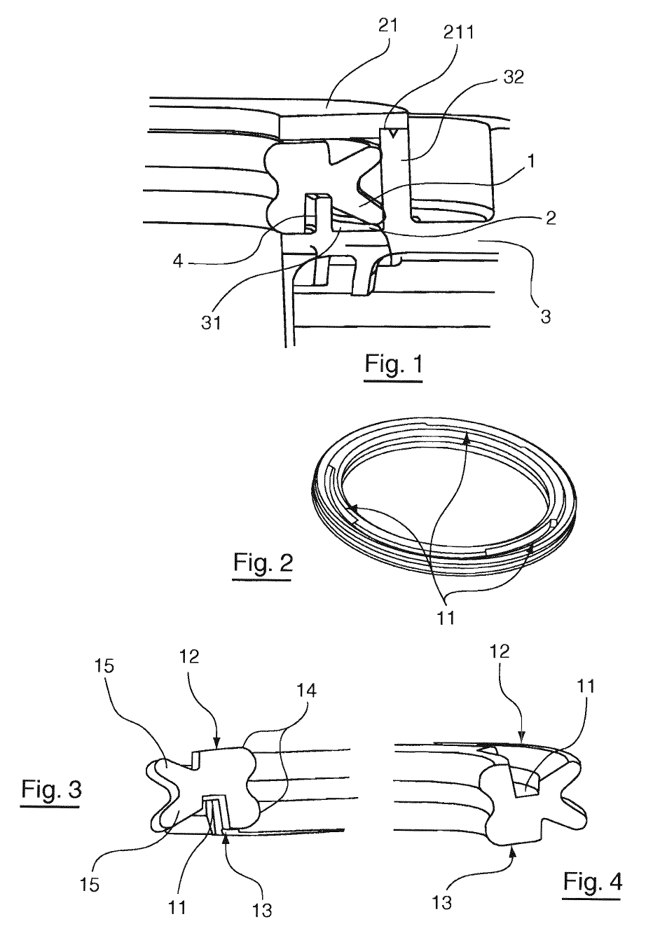

FIG. 1 is a partial cutaway view of an assembly of a gasket on a filter cartridge of the invention;

FIG. 2 is a perspective view of a gasket designed for use with a filter cartridge of the invention;

FIGS. 3 and 4 in each case show a cutaway view of a part of a gasket designed for use with a filter cartridge of the invention;

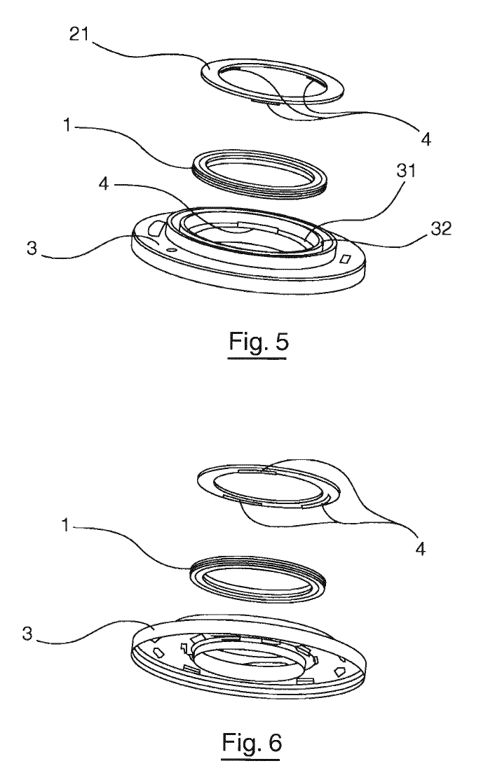

FIGS. 5 and 6 in each case show a partial exploded view of a filter cartridge of the invention.

As indicated previously, the principle of the invention resides in the concept of mounting a gasket in a cavity of a filter cartridge flange, wherein the gasket is retained radially in the cavity in order to reduce the risk of the gasket detaching entirely or partially from the cavity while installing the cartridge on a support tube or while removing the cartridge from the support tube.

According to the method of embodiment illustrated in FIG. 1, the gasket 1 is installed in a cavity 2 arranged in the projection of the bottom flange 3 of the cartridge, said cavity being bound by:
a part 31 of the flange 3;
a crown 32 integrated with the flange 3 and extending perpendicular to the latter and from the latter;
a cover 21 extending in a plane parallel to that of the flange 3.

According to the principle of the invention, the gasket 1 is retained radially (particularly by centripetal means acting to prevent the gasket from detaching from the cavity in the central recess of the cartridge) in the cavity 2, according to the present embodiment, with the help of retention means 4 projecting inside the cavity 2 and penetrating a recess 11 provided in the gasket 1.

It is noted that the flange is made by plastic molding and forms a single-block assembly with the crown 32 and the retention means 4. The cover 21, however, is a part manufactured separately from the flange 3.

With reference to FIG. 2, the recesses of the gasket according to the present embodiment each extend in an arc and are three in number and regularly spaced on the gasket.

Obviously the retention means 4 projecting into the cavity correspond in number and shape to the recesses of the gasket.

It is noted that the number and/or the shape of the recesses of the gasket and/or those of the retention means may be different in other conceivable embodiments, for example:
provision of a plurality of retention means in an arc and a recess on the gasket extending to 360°;
provision of a retention means and a recess that in each case extend to 360°.

As shown in FIGS. 3 and 4, each of the gasket surfaces 12, 13 has recesses 11. As shown in FIG. 3, the recess is on the surface 13 but not on the surface 12, whereas the reverse is true for FIG. 4. In effect, according to a preferred embodiment, the recesses of one surface occupy positions alternating with those of the recesses on the other surface.

As mentioned previously, the cavity 2 in which the gasket is mounted is partially bound by a cover 21, which is directly mounted and fixed on the crown 32.

Preference is given to the cover 21 also having retention means 4 (FIGS. 5 and 6) designed to penetrate the recesses 11 of the corresponding surface of the gasket 1.

The correct radial positioning of the cover with respect to the crown is assured by the presence of a shoulder 211 in the proximity of the outer perimeter of the cover 21, said shoulder being provided to rest on the crown 32.

The cover is fixed on the crown by ultrasound welding.

As illustrated in FIGS. 5 and 6, the manufacture of a filter cartridge according to a preferred embodiment of the invention comprises the following steps:
manufacture of a gasket 1 having recesses spaced at regular angular intervals on each of its surfaces, wherein the recesses of one surface are offset with respect to the recesses of the other surface;
manufacture of a flange forming a single-block assembly with a crown 32 and projecting retention means 4 on the part 31 of the flange 3 extending inside the crown, wherein the retention means are configured and spaced so as to align with the recesses of the gasket;
manufacture of a cover 21 having retention means 4 configured and spaced so as to align with the recesses of the gasket;
positioning of the gasket 1 on the part 31 of the flange by angular alignment of the recesses with the retention means;
positioning of the cover 21 on the crown 32 by angular alignment of the recesses with the retention means;
welding the cover onto the crown 2.

The filtration medium is then integrated with the assembly thus formed and with a second standard flange.

In addition, with reference to FIG. 3, preference is given to the gasket 1 having:
two bosses 14 designed to contact the cartridge support tube;
two lobes 15 extending in divergent directions with respect to each other, wherein each lobe is designed to fit into the corners of the cavity 2 (as illustrated in FIG. 1).

The assembly and the shape of the gasket on one hand, and the design of the support tube on the other hand, are so determined that a fluid pressure acts between the bosses 14 so as to induce a centrifugal radial displacement of the gasket, which tends to induce a compression of the lobes 15 against the walls of the cavity 2 (wherein the V-shape delineated between the lobes then tends to widen further).

In order to permit this radial centrifugal displacement of the gasket, a clearance “j” [Fr: jeu] is provided between the retention means 4 and the recesses 11 of the gasket (wherein said clearance “j” is arranged on the boss side so as to allow a centrifugal displacement of the gasket) by suitable configuration and positioning of the retention means and the recesses.

1. Filter cartridge of a filter assembly for fluid circulating in an engine or a hydraulic machine, designed to cooperate with a central tube, said cartridge comprising a filtration medium, a gasket, and at least one end flange integrated with said medium, said flange projecting to form a cavity for said gasket,
wherein said cavity includes a radial retention means for said gasket.

2. Filter cartridge as in claim 1, wherein said retention means comprise at least one element projecting inside said cavity and penetrating at least one recess of said gasket.

3. Filter cartridge as in claim 2, wherein said projecting element and said recess extend to 360°.

4. Filter cartridge as in claim 2, wherein said retention means comprise a plurality of projecting elements inside said cavity and in each case extending in an arc.

5. Filter cartridge as in claim 4, wherein said gasket has a plurality of recesses whose number and shape correspond to a number of said plurality of projecting elements.

6. Filter cartridge as in claim 5, wherein said gasket has on each of its surfaces at least one recess corresponding to said projecting elements.

7. Filter cartridge as in claim 6, wherein said recesses are on one surface of said gasket and alternate with respect to the recesses that are on an opposite surface of said gasket.

8. Filter cartridge as in claim 1, wherein said cavity is bound by a part of said flange, by a crown integrated with said flange and extending there from, and by a cover directly mounted and fixed on said crown.

9. Filter cartridge as in claim 8, wherein said cover has, on the cavity side, at least one boss penetrating said recess.

10. Filter cartridge as in claim 8, wherein said cover has a shoulder resting on said crown.

11. Filter cartridge as in claim 1, wherein said gasket has two bosses designed to come into contact with said central tube.

12. Filter cartridge as in claim 1, wherein said gasket has two lobes diverging with respect to each other, wherein each of said lobes fits in a corner of said cavity.

13. Filter cartridge as any in claim 2, wherein said retention means with said recess provides a clearance allowing a radial displacement of said gasket.
